(19) United States
(12) Patent Application Publication
(10) Pub. No.: US 2014/0072479 A1
(43) Pub. Date: Mar. 13, 2014

(54) Delivery Equipment for the Solid Precursor Particles

(71) Applicant: NANMAT TECHNOLOGY CO., LTD., Kaohsiung City (TW)

(72) Inventors: Cheng-Jye CHU, Kaohsiung (TW); Yu-Chen ZHENG, Kaohsiung (TW); Chih-Hung CHEN, Kaohsiung (TW); Chi-Hui LIN, Kaohsiung (TW); Meng-Chung CHEN, Kaohsiung (TW)

(73) Assignee: NANMAT TECHNOLOGY CO., LTD., Kaohsiung City (TW)

(21) Appl. No.: 13/669,051

(22) Filed: Nov. 5, 2012

(30) Foreign Application Priority Data
Sep. 13, 2012 (TW) 101133515

(51) Int. Cl. B01J 19/00

(52) U.S. Cl. 422/129

(57) ABSTRACT

The present invention discloses a delivery equipment for the solid precursor particles, which is applied to the deposition of thin film. The delivery equipment for the solid precursor particles mainly comprises a container, a feeding material inlet, a feeding material tube, a feeding gas inlet, a feeding gas tube, and an output. A plurality of solid precursor particles are stored in the carrier liquid of the container, and then heated to be vapor, removed through the output of the container. The solid precursor particles are prepared by sublimation or grounding and uniformly dispersed in the carrier liquid. The disclosed delivery equipment for the solid precursor particles can reduce the required heating temperature, increase the thermal stability, prolong the used life time, and then increase the using efficiency of the precursors.

### BACKGROUND OF THE INVENTION

1. Field of the Invention

The present invention provides a delivery equipment, and more particularly a delivery equipment of solid precursor particle, which can effectively improve the nonuniform heating of the solid precursor, and thus enhance the quality of the deposited film.

2. Description of the Prior Art

In the one or more steps of the deposition devices of semiconductor production, atomic layer deposition (ALD) and atomic Layer Deposition (CVD) are used to deposit one or more layers on substrate, such as single crystal silicon layer, poly crystal silicon layer, amorphous silicon layer, epitaxial layers, carbon fiber, carbon nano fiber, carbon nanotube, silicon oxide, silicon germanium, tungsten, silicon carbon, silicon nitride, silicon oxynitride, titanium nitride, and high-K dielectric materials, on the surface of substrate. In the typical CVD and ALD processes, the solid phase or liquid phase precursors are delivered to a pre-deposition chamber containing multiple substrates. The precursors react under a constant temperature and a constant pressure to form a film on the substrate.

The typical delivery equipment of solid precursor of the prior art is shown in FIG. 1. The delivery equipment consists of long cylindrical container 100, chamber 110, top sealed unit 120 and bottom sealed unit 130. The top sealed unit 120 consists of a filling port 140, an air inlet 150 and an air outlet 160. The carrier gas transported through the air inlet 150 into the chamber 110 can be adjusted by the first control valve. By adjusting the second control valve, the carrier gas can be exhausted through air outlet 160. Nowadays, the solid precursor 170 is directly grounded and put into the chamber 110 and then heated to increase the vapor pressure. When the carrier gas transfers through the air inlet 150 into the chamber 110 containing the solid precursor 170, the carrier gas can mix with the precursor vapor and then exhaust through the air outlet 160. Finally, the carrier gas mixed with the precursor vapor is imported to the CVD equipment. However, the current technology has the problem of difficult to heat conduction within solid precursors, nonuniform heating, aggregation of the solid precursor 170 and poor reproducibility of vapor pressure stability, which causes the film defects and low utilization rate of the solid precursor 170 during the deposition.

U.S. Pat. No. 7,261,118, issued to Birtcher et al, discloses design improvement of the steel cylinder delivering solid precursor in order to improve the problems of vapor pressure. It provides a vessel for conveying a precursor-containing fluid stream from a precursor having a plurality of protrusions that extend into the chamber. The precursor is in contact with the at least one protrusion, in order to improve the nonuniform heating. However, this method will cause it difficult to clean the steel cylinder and then result pollution. Furthermore, molecular sieve, Raschig rings, and other concepts are needed to increase its surface area of the solid precursor and improve the heat conduction. But molecular sieve and Raschig rings are also difficult to clean. Moreover, it is needed to dissolve the solid precursor into solvent, and then remove the solvent by molecular sieve and Raschig rings. Therefore, the cleaning process is more complex, and the solvent is not easy to remove due to porous of molecular sieve and Raschig rings.

U.S. Pat. No. 7,109,113, issued to Derderian et al, discloses a solid source precursor delivery system. The solid source precursor delivery system has either single or multiple stations(s) having a collection/delivery reservoir that is an intermediate stage between a solid source reservoir and a processing deposition chamber. The reservoir can effectively improve the stability of the vapor pressure, and reduce aggregation of the precursor in the reaction chamber. However, an additional reservoir is needed to buffer the vapor pressure of the solid precursor when deposition, which will increase the cost of equipment and decrease the utility rate of the solid precursor.

As for the said delivery method of solid precursor applied to chemical vapor deposition, an air flow will come out when the carrier gas entering the steel cylinder. The air flow will easily carry the particles of the solid precursor without sublimation into the reaction chamber of deposition equipment, thus polluting the deposited film and decreasing the deposited film quality.

U.S. Patent 20060269667, issued to Ma Ce et al, discloses a wide range of low volatility solid precursors dissolved in solvents to form precursor solution. The precursor is selected from the group consisting of halides, alkoxides, β-diketonates, nitrates, alkylamides, amidinates, cyclopentadienyls, and other forms of organic or inorganic metal or non-metal compounds. However, not all solid precursors can be dissolved in the solvent. Moreover, the changes of solubility happened in the heating process may result the precipitation and aggregation of the solid precursor, which is unfavorable to ALD or CVD process.

Furthermore, U.S. Pat. No. 7,722,720, issued to Shenai-Khatkhate et al, discloses delivery devices for delivering solid precursor compounds in the vapor phase to reactors. The delivery device comprises an elongated cylindrical shaped portion, a top closure portion, a bottom closure portion, and the inlet and the outlet chambers in fluid communication and separated by a porous element, the top closure portion having a fill plug and a gas inlet opening. The precursor composition comprises a single layer of solid precursor compound and a single layer of packing material disposed on the solid precursor compound. The used gas is the carrier of the solid precursor compound. In the invention, the fill plug and gas inlet opening communicate with the inlet chamber. In delivery device, the carrier gas flows through the packing material and the solid precursor compound to substantially saturate the carrier gas with the precursor compound, and then the precursor compound saturated carrier gas exiting from the delivery device through the gas outlet. The method provides the precursor with consistent concentration, but the uneven heating of precursor is still problem, thus the method has the disadvantage of decreasing the product stability.

According to the above problems, there is needed to provide a delivery equipment for the solid precursor particles, which can effectively improve the nonuniform heating of the solid precursor, and enhances the quality of the deposited film.

### SUMMARY OF THE DISCLOSURE

The primary objective of the present invention is to provide a delivery equipment for the solid precursor particles, which can effectively minimize the heating temperature of container, improve thermal stability, prolong service life, increase the utility rate of the solid precursor, and improve the quality of as-prepared thin film.

To achieve the main objective, the present invention provides a delivery equipment for the solid precursor particles which mainly comprises a container, a feeding material inlet, a feeding material tube, a feeding gas inlet, a feeding gas tube, and an outlet. The entire length of the container has a substantially constant cross-section, and a top closed portion of the container defines an interior of the container with a bottom closed portion of the container. The container is used to carry a carrier liquid and multiple solid precursor particles, which the solid precursor particles are uniformly dispersed in the carrier liquid with particle size of 10 nm˜100 μm. The feeding material inlet is placed on the top closed portion of the container. The feeding material tube is connected with the feeding material inlet and extended to the interior of the container. The feeding gas inlet is placed on the top closed portion of the container with the feeding material inlet, but not connected with each other. The feeding gas inlet is used to introduce a carrier gas into the container. The feeding gas tube is connected with the feeding gas inlet and extended to the interior of the container. The outlet is placed on the top closed portion of the container with the feeding material inlet and the feeding gas inlet, but not connected with each other. The feeding material tube and the feeding gas tube are both extended to the interior of the container and below a liquid level of the carrier liquid. After a heating process, the solid precursor particle uniformly dispersed in the carrier liquid will sublimate to a precursor vapor. The carrier gas is introduced into the carrier liquid from the feeding gas inlet through the feeding gas tube and then mixed with the precursor vapor to form a mixed gas. And the mixed gas is introduced to a reaction chamber through the outlet.

According to one aspect of the present invention of a delivery equipment for the solid precursor particles, the particle size of the solid precursor particle is better ranged from 20 nm to 500 nm.

The solid precursor particle delivery equipment of the present invention has the following effects:

1. Because the precursor is suspended with nano size in the carrier liquid which acts as heat-transfer medium, the precursor can be heated uniformly to form the vapor of pre-deposition.

2. The carrier liquid not only makes the solid precursor particles not easy to aggregate, but also stabilizes the thermal conduction, which minimizes the heating time.

3. The design of the equipment can lower the needed heating temperature, improve thermal stability, and prolong service life, thus improving the utility rate of the precursor effectively.

4. Because there are no special design and additional stuffing in the container, the cleaning time of the container and the pollution problems can be decreased significantly.

5. The un-sublimated solid precursor particles are not easily carried to the reaction chamber to result the pollution due to the traction of the carrier liquid.

The invention itself, though conceptually explained in above, can be best understood by referencing to the following description, taken in conjunction with the accompanying drawings.

### BRIEF DESCRIPTION OF THE DRAWINGS

FIG. 1: diagram of delivery equipment of solid precursor according to prior arts; and

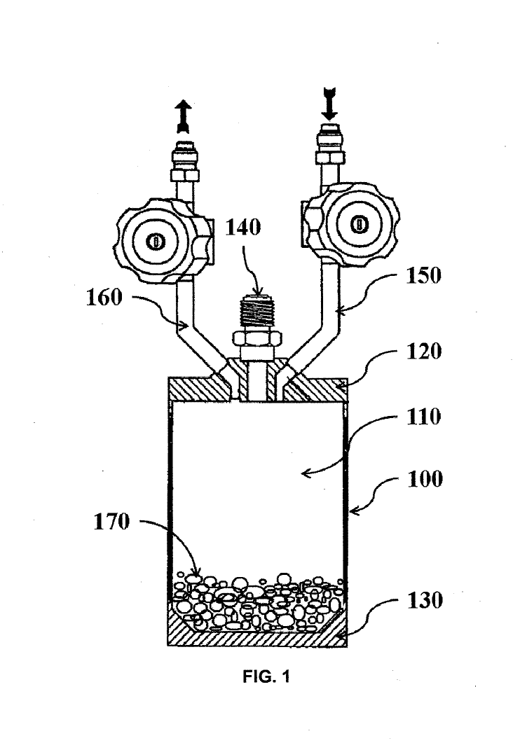

FIG. 2: diagram of delivery equipment of solid precursor according to the present invention.

### DETAILED DESCRIPTION OF THE PREFERRED EMBODIMENTS

Although the invention has been explained in relation to several preferred embodiments, the accompanying drawings and the following detailed descriptions are the preferred embodiment of the present invention. It is to be understood that the following disclosed descriptions will be examples of present invention, and will not limit the present invention into the drawings and the special embodiment.

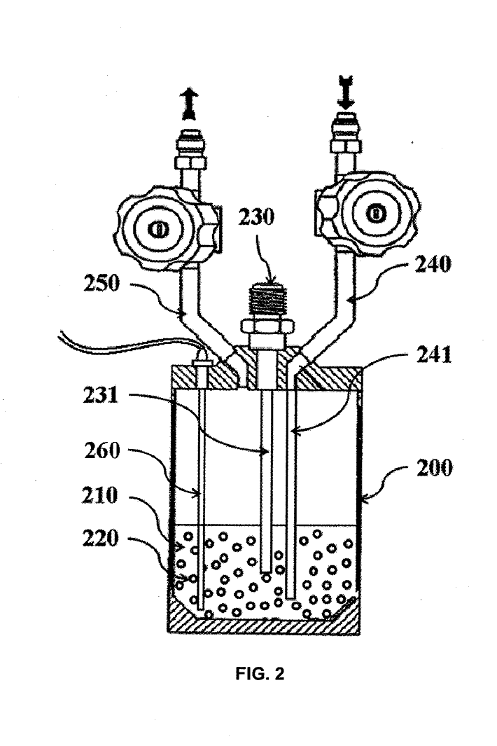

The present invention provides a delivery equipment for the solid precursor particles. Referring to FIG. 2, it shows a schematic of the delivery equipment for the solid precursor particles which mainly comprises a container 200, a feeding material inlet 230, a feeding material tube 231, a feeding gas inlet 240, a feeding gas tube 241, and an outlet 250. The container 200 is usually steel cylinder. The entire length of the container 200 has a substantially constant cross-section, and a top closed portion of the container 200 defines the interior of the container with a bottom closed portion of the container 200. The container 200 is used to carry a carrier liquid 210 and multiple solid precursor particles 220, which the solid precursor particles are uniformly dispersed in the carrier liquid with particle size of 10 nm˜100 μm and of 20 nm˜10 μm, preferably. The more better range of the solid precursor particle size is between 50 nm˜1 μm, and the much better range of the solid precursor particle size is between 50 nm˜500 nm. The feeding material inlet 230 is placed on the top closed portion of the container 200. The feeding material tube 231 is connected with the feeding material inlet 230, and extended to the interior of the container 200. It noted that the feeding material tube 231 is extended down to the carrier liquid 210 in practical.

The feeding gas inlet 240 is placed on the top closed portion of the container 200 with the feeding material inlet 230, but not connected with each other. The feeding gas inlet 240 is used to introduce a carrier gas into the container 200. The carrier gas is gas which cannot react with the carrier liquid 210 and the solid precursor particles 220. The carrier gas is selected from the group consisting of nitrogen, helium, argon, oxygen, ammonia, hydrogen, and water vapor. The feeding gas tube 241 is connected with the feeding gas inlet 240, and extended down to the interior of the container 200. It noted that the feeding gas tube 241 is extended down to the carrier liquid 210 and under the liquid level of the carrier liquid 210 in practical. Moreover, the top closed portion of the container 200 includes a temperature sensor 260. The temperature sensor 260 is extended from the top closed portion of the container 200 to the interior of the container 200. It noted that the temperature sensor 260 is also extended down to the carrier liquid 210 in practical, and is used to measure the reacting temperature of the solid precursor particles 220 in the carrier liquid 210. Because there is no carrier liquid 210 acting as medium in traditional delivery of solid precursor, the reaction temperature of the solid precursor cannot be detected precisely. Furthermore, uneven heating of solid precursor sometimes results the reaction temperature too high to decompose the solid precursor, thus decreasing the utility rate of the solid precursor.

The formation of the solid precursor particles 220 is as follows: A solid precursor bulk placed outside the delivery equipment 20 is sublimated to a precursor vapor by heating, and then is introduced to the feeding material inlet 230 and the feeding material tube and then dispersed within the carrier liquid 230 uniformly to form the solid precursor particles 220. The heating temperature of the solid precursor bulk depends on the sublimation point of the solid precursor bulk, which is between 10° C. and 350° C. The precursor vapor sublimated from the solid precursor bulk is mixed with the carrier gas to form bubbles within the carrier liquid 210 with high viscosity. The precursor vapor will become solid precursor particles dispersed within the carrier liquid 210. The formation of the solid precursor particles is controlled by the temperature of the carrier liquid 210 in the the container 200.

Moreover, the solid precursor bulk can also first mix with the carrier liquid 210 and then be ground to the solid precursor particles 220. Finally, the solid precursor particles 220 is transferred through the feeding material inlet 230 and the feeding material tube 231 into the container 200 to form the carrier liquid 210 containing the solid precursor particles 220. The solid precursor particles 220 can be dispersed within the carrier liquid 210 uniformly by any kinds of mixing processes, such as tap, vibration, rotation, oscillation, shaking, pressing, vibration through electrostriction or magnetostriction converter, or hand-cranked cylinder. The size of the solid precursor particles 220 is between 10 nm and 100 μm, and of 20 nm˜10 μm, preferably. The more better range of the solid precursor particle size is between 50 nm˜1 μm, and the much better range of the solid precursor particle size is between 50 nm˜500 nm.

In practical deposition, the solid precursor particles 220 have been dispersed within the carrier liquid 210. After heating the container 200, the solid precursor particles 220 in the carrier liquid 210 will sublimate to a precursor vapor by a heating process. The carrier gas transfers from a carrier steel cylinder or a gas supply system through a pipe and then enter the carrier liquid 210 through the feeding material inlet 240 and the feeding material tube 241. Finally, the carrier gas is mixed with the precursor vapor to become a mixed gas. The outlet 250, the feeding material inlet 230 and the feeding gas inlet 240 are all placed on the top closed portion of the container 200 but not connected with each other. The mixed gas can be introduced outside to the container 200 through the outlet 250 and transferred to a reaction chamber to proceed with deposition.

The thin film can be deposited by any vapor deposition methods known by the person who familiarizes this technology, for example (but not limited to), chemical vapor deposition (CVD), low pressure CVD (LPCVD), plasma enhanced CVD (PECVD), deposition methods suitable pulse of PECVD, atomic layer deposition (ALD), plasma enhanced ALD (PE-ALD) or a combination thereof. The plasma process can use direct or remote plasma source. The reaction chamber can be any enclosure room or chamber which deposition happens inside the device, such as (but not limited to) the parallel plate reactor, the cold-wall reactor, the hot wall reactor, the single-wafer reactor, the multi-wafer reactor, or the other types of deposition systems, which are under the conditions suitable for the precursor to deposit film.

The heating temperature of the container 200 is between 10° C. and 350° C., the better is between 50° C. and 200° C., and the much better is between 80° C. and 150° C. It has to be noted that the heating temperature of the container 200 is higher than the sublimation point of the solid precursor particles 220 and less than the boiling point of the carrier liquid 210. For example, if the sublimation point of the solid precursor particles 220 is 80° C. and the boiling point of the carrier liquid 210 is 250° C., the heating temperature of the container 200 is between 80° C. and 250° C.

Therefore, after heating the container 200, the solid precursor particles 220 are sublimated, and escaped from the carrier liquid 210, and then transferred to the reaction chamber by the carrier gas. The carrier liquid 210 is stay in the container 200 without participating the deposition process. If the heating temperature is higher than the boiling point of the carrier liquid 210, the carrier liquid 210 will be vaporized and introduced to the reaction chamber accompanying with the precursor vapor, where the deposited sample will be contaminated. Particularly, the carrier liquid 210 will be decomposed to the organic compounds by heating, which will cause the carbon pollution in the reaction chamber.

The reaction chamber, which is connected with the delivery equipment 20 for the solid precursor particles 220, consists of one or more substrates on which thin film will be deposited. The substrates can be any substrate for the manufacture of semiconductor devices, photovoltaic devices, tablet devices or opto-electrical device. The suitable substrates include (but not limited to) silicon substrate, silicon dioxide substrate, silicon nitride substrate, silicon oxynitride substrate, tungsten substrate, titanium nitride, tantalum nitride or combinations thereof. In addition, tungsten or precious metals (such as platinum, palladium, rhodium or gold) are also suitable. The substrate can also consist of one or more layers with various materials deposited in previous.

The temperature and the pressure of the reaction chamber are controlled under the conditions suitable for deposition process. For example, according to the needs of the deposition parameters, the pressure in the reaction chamber can be maintained at between 0.005 torr and 20 torr, and preferably between 0.01 torr and 0.5 torr.

The carrier liquid 210 is selected from the group consisting of alkanes, aromatic and alkenyl, alkynyl class, silicone oil, phosphate ester and ethers. The carrier liquid 210 cannot react with the solid precursor bulk or the solid precursor particles 220 to form other compounds. The solid precursor or the solid precursor particles 220 are soluble or insoluble in the carrier liquid 210. The solid precursor or the solid precursor particles 220 are dispersed uniformly in the carrier liquid 210. The boiling point of the carrier liquid 210 is between 150° C. and 300° C. under one atmosphere. The boiling point of the carrier liquid 210 is between 120° C. and 300° C. under 0.1 torr. In practical deposition, high heating temperature would decompose the solid precursor or the solid precursor particles 220. Therefore, the solid precursor or the solid precursor particles 220 are usually heated under low pressure, thus can lower the sublimation point of the solid precursor and accelerate the vaporization of solid precursor. The carrier liquid 210 with low boiling point is easy to vaporize and decompose during deposition, which will pollute the reaction chamber and the substrate.

Furthermore, the viscosity of the carrier liquid 210 also affects the characteristics of the solid precursor particles 220 dispersed within the carrier liquid 210. The viscosity of the carrier liquid 210 is between 1 cp and 1000 cp. The higher viscosity of the carrier liquid 210 will result aggregation, uneven dispersion and obstruction of the solid precursor particles 220. Moreover, the higher viscosity of the carrier liquid 210 has too large traction for the solid precursor particles 220, so that the solid precursor is not easy to sublimate and transfer to the reaction chamber after heating, thus decreasing the efficiency of deposition. The lower viscosity of the carrier liquid 210 is easy to result the precipitation of the solid precursor particles 220, which lowers the utility rate of the solid precursor particles 220. The better viscosity of the carrier liquid 210 is between 10 cp and 100 cp, preferably.

It is noted that the temperature of the carrier liquid 210 will affect the particle size and the property of the solid precursor particles 220 when the sublimated solid precursor bulk is introduced to the carrier liquid 210 to form the solid precursor particles 220. The more difference between the temperature of the precursor vapor and that of the carrier liquid 210, the more uniform distribution of the solid precursor particles 220, and the smaller size of particles, which is better in vapor deposition. The smaller size of the solid precursor particles 220 is, the larger solid surface area is, thus decreasing the heating time of the solid precursor particles 220 sublimating to a desired vapor pressure. Furthermore, when the heating temperature of the container is decreased, thermal instability will be minimized, and the using life time will be improved, thus increasing the utility rate of the precursor significantly. The higher temperature of the carrier liquid 210 is easy to cause the aggregation and uneven size distribution of the solid precursor particles 220. However, the lower temperature of the carrier liquid 210 accelerates the condensation of the precursor vapor, which makes the precursor vapor condense to solid particles before entering the carrier liquid 210 and stick to the side wall of the feeding material tube 231. In the end, the feeding material tube 231 will be obstructed by the solid precursor.

The solid precursor or the solid precursor particles 220 is the source of precursor vapor used by CVD or ALD. Any applicable delivery equipment of the solid precursor can be used in the present invention. The solid precursor or the solid precursor particles 220 has the general formula of the M-Rₓ, which metal M is selected from the group consisting of Zr, Hf ,Mg, Ta, In, Cu, Ni, Al, Ru, Ce, La, Ni, Ba, Pt, Ag, Au, Co, Ge, Ga, Bi, Ir, Sr, Be, Mn, Mo, and Os; functional group R is selected from the group consisting of ring alkenyl, alkynyl, aromatic, alkyl, amino, halide, alkenyl, and carbonyl. The carbon number of the functional group R is between 1 and 10. The size of the solid precursor particles 220 is between 10 nm and 100 μm, and of 20 nm˜10 μm, preferably. The more better range of the solid precursor particle size is between 50 nm˜1 μm, and the much better range of the solid precursor particle size is between 50 nm˜500 nm. The sublimation point of the solid precursor is between 10° C. and 350° C., and preferably between 10° C. and 200° C. under one standard atmosphere pressure. The sublimation point of the solid precursor is between 0° C. and 200° C., and preferably between 5° C. and 80° C. under 0.1 torr.

The solid precursor or the solid precursor particles 220 include (but not limited to) trimethyl indium, tantalum chloride, nickel chloride, niobium chloride, hafnium chloride, zirconium chloride, platinum chloride, Tetrakis (dimethylamino) zirconium, bis (cyclopentadienyl) magnesium, bis (cyclopentadienyl) ruthenium, bis (cyclopentadienyl) tantalum trihydride, bis (cyclopentadienyl) tantalum tetrahydride, bis (cyclopentadienyl) hafnium dihydride, bis (cyclopentadienyl) zirconium dihydride, bis (cyclopentadienyl) tungsten dihydride, bis (cyclopentadienyl) zirconium dichloride, bis (cyclopentadienyl) hafnium dihydride, bis (cyclopentadienyl) molybdenum dichloride, bis (cyclopentadienyl) lanthium, bis (methylcyclopentadienyl) lanthanum, bis (methylcyclopentadienyl) ruthenium, bis (ethylcyclopentadienyl) lanthanum, isopropylmethylbenzenecyclohexadiene ruthenium, pentakis (dimethylamino) tantalum, copper (N,N-Di-isobutylacetamidinate) [Cu(iBu-Me-amd)]₂, copper (N,N-Di-sec-butylacetamidinate) [Cu(sBu-Me-amd)]₂, copper (N,N-Di-n-propylacetamidinate) [Cu(nPr-Me-amd)]₂, bis (N,N-diisopropylpentylamidinato) manganese.

In prior art, the solid precursor bulks are usually grounded and poured into the container 200 directly, and then the container 200 is heated to increase the vapor pressure of the solid precursor bulks, at the same time. And, the carrier gas takes the precursor vapor to the reaction chamber to the deposition process. Since the morphology of the solid precursor bulk is usually irregular, which makes it difficult to conduct heat within the solid particles, thus the stability of the precursor vapor pressure will be decreased, the defects are easy to appear on the film, and the utility rate of the solid precursor will be minimized. Therefore, the solid precursor particle with uniform particle size according to the present invention can effectively solve these problems.

The solid precursor particles 220 are surrounded by the carrier liquid 210, thus are separated to avoid the aggregation and lowering the heated surface area of the solid precursor particles 220 to improve the instability of the vapor pressure. On the other hand, the carrier liquid 210 can be heat conduction medium, which can improve the uneven heating of the solid precursor and increase the efficacy of vapor deposition.

### EXAMPLE 1

According to the first embodiment of the present invention, the use of the delivery equipment 20 for solid precursor particles 220 is described as follow. 100 g trimethyl indium is put in a sublimator outside the equipment for solid precursor particles 20 and heated to 150° C. to sublimate 50 g trimethyl indium to form trimethyl indium vapor and transferred through the feeding material inlet 230 and the feeding material tube 231 into the container 200 containing the carrier liquid 210 of 500 ml silicon oil. The trimethyl indium vapor in the silicon oil is cooled down and the temperature of the silicon oil is controlled at 5° C. Stir bar is put under the delivery equipment 20 for solid precursor particles 220 to make the trimethyl indium vapor to form the trimethyl indium particles with particle size of 80 nm suspended within the silicon oil. After finishing, the stir bar is removed and the outlet port is locked, and the delivery equipment 20 for solid precursor particles 220 is formed. The delivery equipment 20 for solid precursor particles 220 is placed in the gas cabinet of the deposition equipment and the temperature of the delivery equipment 20 for solid precursor particles 220 is controlled at 20° C. to maintain the silicon oil in the container 200 at 20° C. The pressure in the container 200 is controlled at 0.1 torr. 100 sccm nitrogen gas is introduced as carrier gas to take the trimethyl indium vapor through the outlet 250 to the reaction chamber. After finishing deposition, the residual weight of trimethyl indium is measured to be 1.5 g. The container 200 can be cleaned by ultrasonic oscillator with isopropanol to remove the residue of the solution.

### EXAMPLE 2

According to the second embodiment of the present invention, the use of the delivery equipment 20 for solid precursor particles 220 is described as follow. The preparation method of the solid precursor particles 220 is the same as EXAMPLE 1. The difference is that the carrier liquid 210 is selected from tetradecylphenyl and the temperature of tetradecylphenyl is controlled at 10° C. The container is placed in the gas cabinet of the deposition equipment and the temperature of the delivery equipment 20 for solid precursor particles 220 is controlled at 25° C. to maintain the silicon oil in the container 200 at 25° C. The pressure in the container 200 is controlled at 0.1 torr. 50 sccm nitrogen gas is introduced as carrier gas to take the trimethyl indium vapor to the reaction chamber. After finishing deposition, the residual weight of trimethyl indium is measured to be 2 g.

### EXAMPLE 3

According to the third embodiment of the present invention, the use of the delivery equipment 20 for solid precursor particles 220 is described as follow. First, 100 g pentakis (dimethylamino) tantalum is put in a sublimator outside the equipment for solid precursor particles 20 and heated to 110° C. to sublimate pentakis (dimethylamino) tantalum to form pentakis (dimethylamino) tantalum vapor and transferred through the feeding material inlet 230 and the feeding material tube 231 into the container 200 containing the carrier liquid 210 of 50 ml squalane using 100 sccm nitrogen gas. The pentakis (dimethylamino) tantalum vapor is cooled down to form pentakis (dimethylamino) tantalum particles suspended in the squalane with particle size of 50 nm. The weight of pentakis (dimethylamino) tantalum is measured after reducing 50 g pentakis (dimethylamino) tantalum in the sublimator. The equipment for solid precursor particles 20 is placed in the gas cabinet of the deposition equipment and the temperature of the equipment for solid precursor particles 20 is controlled at 60° C. to maintain the squalane in the container 200 at 60° C. The pressure in the container 200 is controlled at 0.1 torr. 50 sccm nitrogen gas is introduced as carrier gas to take the pentakis (dimethylamino) tantalum vapor to the reaction chamber. After finishing deposition, the residual weight of pentakis (dimethylamino) tantalum is measured to be 1.5 g. The container 200 can be cleaned by ultrasonic oscillator with isopropanol to remove the residue of the solution.

It is noted that the above embodiment may be carried out in an atmospheric or 0.1 torr. The difference is that the lower atmospheric pressure decreases the temperature of the heat treatment.

In traditional, the solid precursor of the prior art is grounded and poured into the container 200, and then the equipment for solid precursor particles 20 is placed in the gas cabinet of the deposition equipment, which the solid residual amount is greater than 15%. However, the disclosed delivery equipment of solid precursor particle of the present invention can reduce the solid residual amount less than 10%, which can improve the utility rate of solid precursor.

The present invention disclosed a delivery equipment for the solid precursor particles, which can effectively minimize the heating temperature of container, improve thermal stability, prolong service life, and increase the utility rate of the solid precursor. The particles will disperse uniformly by solution which acts as thermal conduction medium to reduce uneven heating.

In summary, the solid precursor particle delivery equipment of the present invention has the following effects:

1. Because the precursor is suspended with nano size in the carrier liquid which acts as heat-transfer medium, the precursor can be heated uniformly and form the vapor of pre-deposition.

2. The carrier liquid not only makes the solid precursor particles not easy to aggregate, but also stabilizes the thermal conduction, which minimizes the heating time.

3. The design of the equipment can lower the needed heating temperature, improve thermal stability, and prolong service life, thus improving the utility rate of the precursor effectively.

4. Because there are no special design and additional stuffing in the container, the cleaning time of the container and the pollution problems can be decreased significantly.

5. The un-sublimated solid precursor particles are not easily carried to the reaction chamber to result the pollution due to the traction of the carrier liquid.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A delivery equipment for the solid precursor particles comprising:
a container, the entire length of the container having a substantially constant cross-section, and a top closed portion of the container defining an interior of the container with a bottom closed portion of the container, the container used to carry a carrier liquid and multiple solid precursor particles, which the solid precursor particles are uniformly dispersed in the carrier liquid with particle size of 10 nm˜100 μm;
a feeding material inlet, placed on the top closed portion of the container;
a feeding material tube, connected with the feeding material inlet and extended to the interior of the container;
a feeding gas inlet, placed on the top closed portion of the container with the feeding material inlet but not connected to each other, the feeding gas inlet used to introduce a carrier gas into the container;
a feeding gas tube, connected with the feeding gas inlet and extended to the interior of the container;
an outlet, placed on the top closed portion of the container with the feeding material inlet and the feeding gas inlet but not connected to each other;
wherein both the feeding material inlet and the feeding gas inlet are extended down to the interior of the container and below a liquid level of the carrier liquid;
the solid precursor particle uniformly dispersed in the carrier liquid are sublimated to a precursor vapor after a heating process;
the carrier gas is introduced into the carrier liquid from the feeding gas inlet through the feeding gas tube and then mixed with the precursor vapor to form a mixed gas; and
the mixed gas is introduced to a reaction chamber through the outlet.

2. The delivery equipment as claimed in claim 1, wherein the particle size of the solid precursor particle is ranged from 20 nm to 500 nm, preferably.

3. The delivery equipment as claimed in claim 1, wherein the temperature of the heating process is higher than the sublimation point of the solid precursor particle and less than a boiling point of the carrier liquid.

4. The delivery equipment as claimed in claim 3, wherein the temperature of the heating process is between 10° C.˜350° C.

5. The delivery equipment as claimed in claim 1, wherein the solid precursor has the general formula of the M-Rx, which metal M is selected from the group consisting of Zr, Hf ,Mg, Ta, In, Cu, Ni, Al, Ru, Ce, La, Ni, Ba, Pt, Ag, Au, Co, Ge, Ga, Bi, Ir, Sr, Be, Mn, Mo, and Os, and functional group R is selected from the group consisting of ring alkenyl, alkynyl, aromatic, alkyl, amino, halide, alkenyl, and carbonyl.

6. The delivery equipment as claimed in claim 5, wherein the sublimation point of the solid precursor is between 50° C. and 500° C.

7. The delivery equipment as claimed in claim 5, wherein the solid precursor is selected from the group consisting of trimethyl indium, tantalum chloride, nickel chloride, niobium chloride, hafnium chloride, zirconium chloride, platinum chloride, Tetrakis (dimethylamino) zirconium, bis (cyclopentadienyl) magnesium, bis (cyclopentadienyl) ruthenium, bis (cyclopentadienyl) tantalum trihydride, bis (cyclopentadienyl) tantalum tetrahydride, bis (cyclopentadienyl) hafnium dihydride, bis (cyclopentadienyl) zirconium dihydride, bis (cyclopentadienyl) tungsten dihydride, bis (cyclopentadienyl) zirconium dichloride, bis (cyclopentadienyl) hafnium dihydride, bis (cyclopentadienyl) molybdenum dichloride, bis (cyclopentadienyl) lanthium, bis (methylcyclopentadienyl) lanthanum, bis (methylcyclopentadienyl) ruthenium, bis (ethylcyclopentadienyl) lanthanum, isopropylmethylbenzenecyclohexadiene ruthenium, pentakis (dimethylamino) tantalum, copper (N,N-Di-isobutylacetamidinate) [Cu(iBu-Me-amd)]₂, copper (N,N-Di-sec-butylacetamidinate) [Cu(sBu-Me-amd)]₂, copper (N,N-Di-n-propylacetamidinate) [Cu(nPr-Me-amd)]₂, bis (N,N-diisopropylpentylamidinato) manganese.

8. The delivery equipment as claimed in claim 1, wherein the carrier liquid is selected from the group consisting of alkanes, aromatic and alkenyl, alkynyl class, silicone oil, phosphate ester and ethers.

9. The delivery equipment as claimed in claim 3, wherein the boiling point of the carrier liquid is between 120° C. and 300° C. under 0.1 torr.

10. The delivery equipment as claimed in claim 1, wherein a viscosity of the carrier liquid is between 1 cp and 1000 cp.

11. The delivery equipment as claimed in claim 1, wherein the viscosity of the carrier liquid is between 10 cp and 100 cp, preferably.

12. The delivery equipment as claimed in claim 1, wherein the delivery equipment further comprises a temperature sensor, which extends from the top closed portion of the container to the bottom closed portion of the interior of the container.
